(19) United States
(12) Patent Application Publication
(10) Pub. No.: US 2026/0028437 A1
(43) Pub. Date: Jan. 29, 2026

(54) STYRENE-DIENE POLYMER EMULSION COMPOSITIONS AND METHODS OF MAKING AND USE THEREOF

(71) Applicant: Infineum International Limited, Linden, NJ (US)

(72) Inventors: Eric Silver, Jersey City, NJ (US); Pui Lam Chiu, Short Hills, NJ (US); Nga Nguyen, Scotch Plains, NJ (US); Ewan K. Galbraith, Kingston, NY (US)

(73) Assignee: Infineum International Limited, Linden, NJ (US)

(21) Appl. No.: 19/278,982

(22) Filed: Jul. 24, 2025

Related U.S. Application Data
(60) Provisional application No. 63/674,938, filed on Jul. 24, 2024.

(51) Int. Cl. C08F 36/06; C08F 6/14; H01M 4/02; H01M 4/134; H01M 4/38; H01M 4/62; H01M 4/66

(52) U.S. Cl. CPC C08F 36/06; C08F 6/14; H01M 4/134; H01M 4/386; H01M 4/622; H01M 4/625; H01M 4/661; H01M 2004/021; H01M 2004/027

(57) ABSTRACT

Provided is an aqueous based styrene-diene polymer emulsion composition including: i) from 2 to 50 wt. % of one or more polymers including linear polymers characterized by the formula:

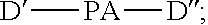

star polymers characterized by the formula:

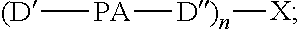

or combinations thereof; wherein D′, PA, D″, n and X are defined herein; ii) from 0.05 to 5.0 wt. % of one or more surfactants; and iii) the remainder of the composition comprising water. Also provided are an electrode slurry composition for a secondary metal ion battery composition, a secondary metal ion battery anode, a method of improving the life of a secondary metal ion battery, a method of making an aqueous based styrene-diene polymer emulsion composition, and a method of making an electrode slurry composition for a secondary metal ion battery.

### CROSS-REFERENCE TO RELATED APPLICATION

This U.S. Non-provisional application claims priority to U.S. Provisional Application Ser. No. 63/674,938 filed on Jul. 24, 2024, the contents of which are herein incorporated by reference in their entirety.

### FIELD

This disclosure relates to aqueous emulsions of styrene-diene polymers. More particularly, this disclosure relates to aqueous based styrene-diene polymer emulsion compositions including linear or star styrene-diene polymers, one or more surfactants and water. This disclosure also relates to methods of making such emulsions and the use of such emulsions in an electrode slurry composition for a secondary metal ion battery for improving battery life.

### BACKGROUND

Secondary metal ion batteries include both an anode and a cathode. These electrodes are typically coated with a polymer based slurry composition that serves to form a uniform layer of active material that adheres to the current collector and retains structural integrity during the life time of the battery. Silicon (Si) has been extensively pioneered to be the next most important anode material used in secondary lithium ion battery (LiB) to replace graphite due to the added high capacity (×4) and fast charging capabilities (via thinner electrode). The addition of a low level of Si (˜5%) to anode formulations have been proven to meet 3rd generation electric vehicle (EV) targets in terms of battery performance. However, at higher Si level, Si-anode materials experience high volume changes (4×) during lithiation-delithiation which leads to the following issues: (1) pulverization or cracking of Si particles; (2) delamination of functional coating from the current collector; and (3) unstable solid-electrolyte interface (SEI). These problems cannot be resolved using currently available polymeric binder materials, which are predominately styrene butadiene rubber (SBR) in combination with carboxymethyl cellulose (CMC) or polyacrylic acid (PAA) as co-binder materials in the polymer based slurry for coating on the battery anode.

Hence, there is a need for improved polymeric binder materials for use in slurries used in coating battery electrodes to improve the overall performance of the battery in terms of life. The polymeric binders are typically introduced into the slurries as polymer emulsions in water to both aid in handleability, and the mixing process to form homogenous blends prior to coating the electrode.

### SUMMARY

According to the present disclosure, an advantageous aqueous based styrene-diene polymer emulsion composition comprises: i) from 2 to 50 wt. % of one or more polymers comprising linear polymers characterized by the formula:

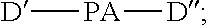

star polymers characterized by the formula:

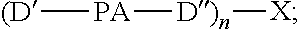

combinations thereof;

wherein D′ represents a block derived from diene; PA represents a block derived from monoalkenyl arene; D″ represents a block derived from diene; n represents the average number of arms per star polymer formed by the reaction of 2 or more moles of a polyalkenyl coupling agent per mole of arms; and X represents a nucleus of a polyalkenyl coupling agent; wherein at least one of diene blocks D′ and D″ is a copolymer block derived from mixed diene monomer, in which from 65 wt. % to 95 wt. % of the incorporated monomer units are from isoprene and from 5 wt. %, up to 35 wt. % of the incorporated monomer units are from butadiene; wherein at least 80 wt. % of the butadiene is incorporated in a 1, 4-configuration; and wherein D′ has a number average molecular weight of from 10,000 to 120,000 daltons; PA has a number average molecular weight of from 10,000 to 50,000 daltons; and D″ has a number average molecular weight of from 5,000 to 60,000 daltons; ii) from 0.05 to 5.0 wt. % of one or more surfactants selected from the group consisting of anionic surfactants, cationic surfactants, nonionic surfactants, amphoteric surfactants, and combinations thereof; and iii) the remainder of the composition comprising water.

A further aspect of the present disclosure relates to an advantageous method of making an aqueous based styrene-diene polymer emulsion composition comprising the steps of: i) providing one or more polymers comprising linear polymers characterized by the formula:

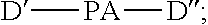

star polymers characterized by the formula:

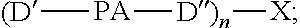

combinations thereof;
wherein D′ represents a block derived from diene; PA represents a block derived from monoalkenyl arene; D″ represents a block derived from diene; n represents the average number of arms per star polymer formed by the reaction of 2 or more moles of a polyalkenyl coupling agent per mole of arms; and X represents a nucleus of a polyalkenyl coupling agent; wherein at least one of diene blocks D′ and D″ is a copolymer block derived from mixed diene monomer, in which from 65 wt. % to 95 wt. % of the incorporated monomer units are from isoprene and from 5 wt. %, up to 35 wt. % of the incorporated monomer units are from butadiene; wherein at least 80 wt. % of the butadiene is incorporated in a 1, 4-configuration; and wherein D′ has a number average molecular weight of from 10,000 to 120,000 daltons; PA has a number average molecular weight of from 10,000 to 50,000 daltons; and D″ has a number average molecular weight of from 5,000 to 60,000 daltons; ii) dissolving the one or more polymers into one or more organic solvents to form one or more dissolved polymers; iii) providing an aqueous surfactant solution including one or more surfactants selected from the group consisting of anionic surfactants, cationic surfactants, nonionic surfactants, amphoteric surfactants, and combinations thereof; iv) combining and mixing the one or more dissolved polymers and the aqueous surfactant solution; v) further mixing the combined one or more dissolved polymers and aqueous surfactant solution; and vi) stirring the mixed one or more dissolved polymers and aqueous surfactant solution at a temperature of from 20 to 75° C. and for a sufficient time to completely evaporate the one or more organic solvents to form the aqueous based styrene-diene polymer emulsion composition.

Another aspect of the present disclosure relates to an advantageous method of making an electrode slurry composition for a secondary metal ion battery comprising the steps of: i. dispersing into an aqueous solution one or more conductive carbon-based particles selected from the group consisting of carbon nanotubes, graphites, and combinations thereof, and one or more of silicon based particles; ii. mixing into the aqueous solution an aqueous based styrene-diene polymer emulsion composition described above; and iii. further mixing into the aqueous solution one or more co-binders selected from the group consisting of polyacrylic acid, carboxymethyl cellulose, hydroxyethyl cellulose, polyvinyl alcohol, polyurethane, and combinations thereof to form the electrode slurry composition.

A still another aspect of the present disclosure relates to a secondary metal ion battery anode comprising: a copper foil substrate having a thickness of from 5 to 50 microns; and a continuous coating layer having a thickness of from 50 to 500 microns on one surface of the copper foil substrate; wherein the continuous coating layer comprises: from 10 to 80 wt. % of one or more conductive carbon-based particles selected from carbon nanotubes, graphites, and combinations thereof; from 1 to 80 wt. % of one or more of silicon based particles; from 1 to 10 wt. % of one or more polymer binders comprising linear polymers characterized by the formula:

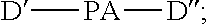

star polymers characterized by the formula:

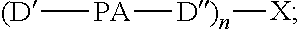

combinations thereof; wherein D′ represents an “outer” block derived from diene having a number average molecular weight of from about 10,000 to about 120,000 daltons; PA represents a block derived from monoalkenyl arene having a number average molecular weight of from about 10,000 to about 50,000 daltons; D″ represents an inner random block derived from diene having a number average molecular weight of from about 5,000 to about 60,000 daltons; n represents the average number of arms per star polymer formed by the reaction of 2 or more moles of a polyalkenyl coupling agent per mole of arms; and X represents a nucleus of a polyalkenyl coupling agent; and from 0 to 10 wt. % of one or more co-binders selected from the group consisting of polyacrylic acid, carboxymethyl cellulose, hydroxyethyl cellulose, polyvinyl alcohol, polyurethane, and combinations thereof.

These and other features and attributes of the disclosed aqueous based styrene-diene polymer emulsion compositions and methods of making and use thereof of the present disclosure and their advantageous applications and/or uses will be apparent from the detailed description which follows, particularly when read in conjunction with the figures appended hereto.

### BRIEF DESCRIPTION OF THE DRAWINGS

FIG. 1 depicts a graph of capacity retention as function of the number of cycles of the battery.

FIG. 2 depicts a graph of rate capability in 2 C-rates as function of the number of cycles of the battery.

### DETAILED DESCRIPTION

All numerical values within the detailed description and the claims herein are modified by “about” or “approximately” the indicated value, and take into account experimental error and variations that would be expected by a person having ordinary skill in the art.

### Overview

The present disclosure provides novel aqueous based styrene-diene polymer emulsion compositions. The styrene-diene polymer emulsion compositions disclosed herein include surfactant and water, and find application as a binder or co-binder for secondary metal ion battery electrodes. In such application, the styrene-diene polymer emulsion compositions provided herein, provide the following advantages including, but not limited to: improved battery life, improved structural/mechanical integrity of the anode, enhanced charging rate capability and capacity retention, and enhanced processability. The styrene-diene polymer emulsion compositions disclosed herein may be blended with other components, including, but not limited to, one or more co-binders, one or more conductive carbon-based particles, and one or more of silicon-based particles to form an electrode slurry composition. Also provided herein are methods of improving the life of a secondary metal ion battery by using the electrode slurry composition disclosed herein as a binder for a coating of an anode of the secondary metal ion battery.

The present disclosure also provides methods of making an aqueous based styrene-diene polymer emulsion composition and methods of making an electrode slurry composition for a secondary metal ion battery. The present disclosure also provides methods of using an aqueous based styrene-diene polymer emulsion composition and methods of using an electrode slurry composition including the aqueous based styrene-diene polymer emulsion as binder or a co-binder for an electrode of a secondary metal ion battery. The present disclosure also provides for a secondary metal ion battery anode that includes one or more polymer binders or co-binders comprising the one or more styrene-diene polymers disclosed herein.

The compositions and methods provided herein are distinguishable over the prior art by including novel aqueous based styrene-diene polymer emulsion compositions, which offer significant advantages relative to prior art polymer emulsion compositions including styrene-butadiene rubber and carboxymethyl cellulose.

The advantageous properties and/or characteristics of the disclosed novel aqueous based styrene-diene polymer emulsion compositions as binders or co-binders in secondary metal ion battery electrode application include, inter alia, improved battery life, improved structural/mechanical integrity of the anode, enhanced charging rate capability and capacity retention, and enhanced processability.

### Styrene-Diene Polymer Emulsion Compositions

Disclosed herein are aqueous based styrene-diene polymer emulsion compositions comprising: i) from 2 to 50 wt. %, or 4 to 40 wt. %, or 6 to 30 wt. %, or 8 to 25 wt. %, or 10 to 20 wt. %, or 13 to 17 wt. % of one or more polymers comprising linear polymers characterized by the formula: D′-PA-D″; star polymers characterized by the formula: (D′-PA-D″) n-X; or combinations thereof; ii) from 0.05 to 5.0 wt. %, or 0.1 to 4.5 wt. %, or 0.5 to 4.0 wt. %, or 1.0 to 3.5 wt. %, or 1.5 to 3.0 wt. %, or 2.0 to 2.5 wt. % of one or more ionic surfactants, one or more non-ionic surfactants, or a combination thereof; and iii) the remainder of the composition comprising water.

For the one or more polymers above, D′ represents a block derived from diene; PA represents a block derived from monoalkenyl arene; D″ represents a block derived from diene; n represents the average number of arms per star polymer formed by the reaction of 2 or more moles of a polyalkenyl coupling agent per mole of arms; and X represents a nucleus of a polyalkenyl coupling agent. For the one or more polymers above, at least one of diene blocks D′ and D″ may be a copolymer block derived from mixed diene monomer, in which from 65 wt. % to 95 wt. %, or 70 wt. % to 90 wt. %, 75 wt. % to 85 wt. %, of the incorporated monomer units are from isoprene and from 5 wt. %, up to 35 wt. %, or 10 wt. % to 30 wt. %, or 15 wt. % to 25 wt. % of the incorporated monomer units are from butadiene. Also for the one or more polymers above, at least 80 wt. %, or at least 85 wt. %, or at least 90 wt. %, or at least 95 wt. % of the butadiene may be incorporated in a 1, 4-configuration.

D′ may have a number average molecular weight of from 10,000 to 120,000 daltons, or 15,000 to 100,000 daltons, or 20,000 to 80,000 daltons, or 25,000 to 60,000 daltons, or 30,000 to 40,000 daltons. PA may have a number average molecular weight of from 10,000 to 50,000 daltons, or 15,000 to 45,000 daltons; or 20,000 to 40,000 daltons, or 25,000 to 35,000 daltons. D″ may have a number average molecular weight of from 5,000 to 60,000 daltons, or 10,000 to 50,000 daltons, or 15,000 to 40,000 daltons, or 20,000 to 30,000 daltons.

Still alternatively, the one or more styrene-diene polymers above may have a D′ with a number average molecular weight of from 20,000 to 60,000 daltons, or 25,000 to 55,000 daltons, or 30,000 to 50,000 daltons, or 35,000 to 45,000 daltons. Still alternatively, the one or more styrene-diene polymers above may have a D″ with a number average molecular weight of from 10,000 to 30,000 daltons, or 15,000 to 25,000 daltons, or 17,000 to 22,000 daltons. Still alternatively, the one or more styrene-diene polymers above may have a PA with a number average molecular weight of from 12,000 to 35,000 daltons, or 15,000 to 30,000 daltons, or 18,000 to 28,000 daltons, or 20,000 to 25,000 daltons.

The one or more styrene-diene polymers above may have a ratio between the number average molecular weight of D′ and the number average molecular weight of D″ of at least 1.4:1, or 2.0:1, or 2.5:1, or 3.0:1. The one or more styrene-diene polymers above may have a ratio between the number average molecular weight of PA and the number average molecular weight of D″ of at least 0.75:1, or at least 0.85:1, or at least 0.95:1, or at least 1.05:1, at least 1.15:1.

The one or more styrene-diene polymers above may comprise linear polymers that are a diblock, a triblock or combinations thereof. For the linear polymers, a total number average molecular weight of may range from 40,000 daltons to 1,000,000 daltons, or 80,000 daltons to 800,000 daltons, or 100,000 daltons to 600,000 daltons, or 150,000 daltons to 550,000 daltons, or 200,000 daltons to 500,000 daltons, 250,000 daltons to 450,000 daltons, or 300,000 daltons to 400,000 daltons.

Alternatively, the one or more styrene-diene polymers above may comprise star polymers including arms that are homopolymer, diblock, triblock or combinations thereof type of arms. For the one or more styrene-diene polymers that are star polymers, the number of arms, n, may be on average, from 4 to 25, or 7 to 22, or 10 to 20, or 12 to 18, or 14 to 16. For the star polymers, a total number average molecular weight may range from 100,000 daltons to 1,000,000 daltons, or 150,000 daltons to 800,000 daltons, or 200,000 daltons to 600,000 daltons, or 250,000 daltons to 550,000 daltons, or 300,000 daltons to 500,000 daltons, 350,000 daltons to 450,000 daltons.

The aqueous based styrene-diene polymer emulsion compositions disclosed herein include the emulsified styrene-diene polymer having a particle size ranging from 50 to 1000 nm, or 75 to 950 nm, or 100 to 900 nm, or 125 to 850 nm, or 150 to 800 nm, or 175 to 750 nm, or 200 to 700 nm, or 225 to 650 nm, or 250 to 600 nm, or 275 to 550 nm, or 300 to 500 nm, or 325 to 475 nm, or 350 to 450 nm, or 375 to 425 nm.

The aqueous based styrene-diene polymer emulsion compositions disclosed herein may have a pH ranging from 4.0 to 10.0, or 4.5 to 9.5, or 5.0 to 9.0, or 5.5 to 8.5, or 6.0 to 8.0, or 6.5 to 7.5. The aqueous based styrene-diene polymer emulsion compositions disclosed herein may have a viscosity at 25° C. as measured by ASTM D5133 of from 20 to 1000 cP, or 30 to 950 cP, or 40 to 900 cP, or 50 to 850 cP, or 60 to 800 cP, or 70 to 750 cP, or 80 to 700 cP, or 90 to 650 cP, or 100 to 600 cP, or 150 to 550 cP, or 200 to 500 cP, or 250 to 450 cP, or 300 to 400 cP.

A polymer film of the aqueous based styrene-diene polymer emulsion compositions disclosed herein may have an electrical conductivity from 0.00001 to 1 mS/cm, or 0.00005 to 0.5 mS/cm, or 0.0001 to 0.1 mS/cm.

The aqueous based styrene-diene polymer emulsion compositions disclosed herein may include one or more surfactants, and more particularly, one or more anionic surfactants, cationic surfactants, nonionic surfactants, amphoteric surfactants, and combinations thereof. The aqueous based styrene-diene polymer emulsion compositions disclosed herein may include one or more ionic surfactants that are selected from the group consisting of sodium dodecyl sulfonate, alkyl surfactants, silicone surfactants, fluorine surfactants, metal surfactants, other ionic surfactants described below, and combinations thereof. The aqueous based styrene-diene polymer emulsion compositions disclosed herein may also include one or more non-ionic surfactants that are selected from the group consisting of silicone surfactants, fluorine surfactants, alkyl surfactants, polyether-based surfactants, other non-ionic surfactants described below, and combinations thereof.

### Styrene-Diene Polymers

Polymer emulsions of the instant disclosure include one or more polymers that are linear polymers, which can be characterized by the formula:

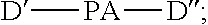

star polymers characterized by the formula:

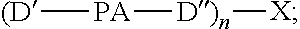

combinations thereof.

D′ represents a block derived from diene; PA represents a block derived from monoalkenyl arene; D″ represents a block derived from diene; n represents the average number of arms per star polymer formed by the reaction of 2 or more moles of a polyalkenyl coupling agent per mole of arms; and X represents a nucleus of a polyalkenyl coupling agent. At least one of diene blocks D′ and D″ is a copolymer block derived from mixed diene monomer, in which from 65 wt. % to 95 wt. % of the incorporated monomer units are from isoprene and from 5 wt. %, up to 35 wt. % of the incorporated monomer units are from butadiene and wherein at least 80 wt. % of the butadiene is incorporated in a 1, 4-configuration. D′ has a number average molecular weight of from 10,000 to 120,000 daltons; PA has a number average molecular weight of from 10,000 to 50,000 daltons; and D″ has a number average molecular weight of from 5,000 to 60,000 daltons.

In another form of the polymer emulsions of the instant disclosure, the one or more polymers described above are such that D′ represents an “outer” block derived from diene; PA represents a block derived from monoalkenyl arene; D″ represents an inner random block derived from diene; n represents the average number of arms per star polymer formed by the reaction of 2 or more moles of a polyalkenyl coupling agent per mole of arms; and X represents a nucleus of a polyalkenyl coupling agent. At least one of diene blocks D′ and D″, preferably each of diene blocks D′ and D″, are copolymer blocks derived from mixed diene monomer, in which from about 65 wt. % to about 95 wt. % of the incorporated monomer units are from isoprene and from about 5 wt. %, up to about 35 wt. % of the incorporated monomer units are from butadiene, and wherein at least about 80 wt. % of butadiene, preferably at least 90 wt. % of the butadiene is incorporated in a 1, 4-configuration. Preferably, at least about 15 wt. % of the incorporated monomer units are butadiene monomer units. Preferably, no greater than about 28 wt. % of the incorporated monomer units are butadiene monomer units. Preferably, at least one of diene blocks D′ and D″, more preferably each of diene blocks D′ and D″, are random copolymer blocks.

For each of the forms of the polymer emulsions of the instant disclosure including one or more polymers described above, blocks D′ and D″ are preferably hydrogenated to remove at least about 80% or 90% or 95% of unsaturations, and more preferably, are fully hydrogenated. Outer block D′ has a number average molecular weight of from about 10,000 to about 120,000 daltons, more preferably from about 20,000 to about 60,000 daltons, before hydrogenation. Block PA has a number average molecular weight of from about 10,000 to about 50,000 daltons.

In addition to the size of blocks D′, PA, and D″, the ratio between both the size of outer block D′ and inner block D″, and block PA and inner block D″, has been found to influence the emulsion stability properties of the star polymer. In star polymers of the present disclosure, the ratio of the number average molecular weight of outer block D′ to the number average molecular weight of inner block D″ is preferably at least about 1.4:1, such as at least about 1.9:1, more preferably at least about 2.0:1, and the ratio of the number average molecular weight of block PA to the number average molecular weight of inner block D″ is preferably at least about 0.75:1, such as at least about 0.9:1, more preferably at least about 1.0:1.

Preferably no greater than 30 wt. %, more preferably no greater than 25 wt. %, of the total amount of polydiene in the star polymers of the disclosure is derived from butadiene. Preferably, at least about 80 wt. %, more preferably, at least 90 wt. % of the total amount of butadiene, which can be incorporated into the polymer as 1, 2—, or 1, 4-configuration units, is incorporated into the star polymer is incorporated in a 1, 4-configuration. Increasing the percentage of butadiene incorporated into the polymer as 1, 4-units can increase the thickening efficiency properties of the star polymer and help improve the coating ability.

Isoprene monomers used as the precursors of the copolymers of the present disclosure can be incorporated into the polymer in either a 1, 4- or 3, 4-configuration, or as a mixture thereof. Preferably, the majority of the isoprene is incorporated into the polymer as 1, 4-units, such as greater than about 60 wt. %, more preferably greater than about 80 wt. %, such as about 80 to 100 wt. %, most preferably greater than about 90 wt. %, such as about 93 wt. % to 100 wt. %.

Suitable monoalkenyl arene monomers include monovinyl aromatic compounds, such as styrene, monovinylnaphthalene, as well as the alkylated derivatives thereof, such as o-, m- and p-methylstyrene, alpha-methyl styrene and tertiary-butylstyrene. The preferred monoalkenyl arene is styrene.

Linear polymers of the present disclosure may have a number average molecular weight of from about 25,000 daltons to about 1,000,000 daltons, such as from about 40,000 daltons to about 500,000 daltons, preferably from about 60,000 daltons to about 200,000 daltons. The linear polymer may be diblock, triblock or combinations thereof. Star polymers of the present disclosure can have from 4 to about 25 arms (n=about 4 to about 25), preferably from about 10 to about 20 arms. The star polymers of the instant disclosure can have polymers arms that are homopolymer, diblock, triblock, or combinations thereof. Star polymers of the present disclosure may have a total number average molecular weight of from about 100,000 daltons to about 1,000,000 daltons, preferably from about from about 400,000 to about 800,000 daltons, most preferably from about 500,000 to about 700,000 daltons.

The triblock linear polymers and triblock arms of the star polymers of the present disclosure can be formed as living polymers via anionic polymerization, in solution, in the presence of an anionic initiator, as described, for example, in U.S. Pat. No. 4,116,917. The preferred initiator is lithium or a monolithium hydrocarbon. Suitable lithium hydrocarbons include unsaturated compounds such as allyl lithium, methallyl lithium; aromatic compounds such as phenyllithium, the tolyllithiums, the xylyllithiums and the naphthyllithiums, and in particular, the alkyl lithiums such as methyllithium, ethyllithium, propyllithium, butyllithium, amyllithium, hexyllithium, 2-ethylhexyllithium and n-hexadecyllithium. Secondary-butyllithium is the preferred initiator. The initiator(s) may be added to the polymerization mixture in two or more stages, optionally together with additional monomer.

The triblock linear polymers and triblock arms of the star polymers of the present disclosure can, and are preferably, prepared by step-wise polymerization of the monomers e.g., polymerizing the random polyisoprene/polybutadiene copolymer, followed by the addition of the other monomer, specifically monoalkenyl arene monomer, followed by the polymerization of the second random polyisoprene/polybutadiene copolymer to form a living polymer having the formula polyisoprene/polybutadiene-polyalkenyl arene-polyisoprene/polybutadiene-X.

The living polyisoprene/polybutadiene copolymer blocks D′ and/or D″, in the absence of the proper control of the polymerization will, as described in U.S. Pat. No. 7,163,913, not be a random copolymer and will instead comprise a polybutadiene block, a tapered segment containing both butadiene and isoprene addition product, and a polyisoprene block. To prepare a random copolymer, the more reactive butadiene monomer may be added gradually to the polymerization reaction mixture containing the less reactive isoprene such that the molar ratio of the monomers in the polymerization mixture is maintained at the required level. It is also possible to achieve the required randomization by gradually adding a mixture of the monomers to be copolymerized to the polymerization mixture. Living random copolymers may also be prepared by carrying out the polymerization in the presence of a so-called randomizer. Randomizers are polar compounds that do not deactivate the catalyst and randomize the manner in which the monomers are incorporated into to the polymer chain. Suitable randomizers are tertiary amines, such as trimethylamine, triethylamine, dimethylamine, tri-n-propylamine, tri-n-butylamine, dimethylaniline, pyridine, quinoline, N-ethyl-piperidine, N-methylmorpholine; thioethers, such as dimethyl sulfide, diethyl sulfide, di-n-propyl sulfide, di-n-butyl sulfide, methyl ethyl sulfide; and in particular, ethers such as dimethyl ether, methyl ether, diethyl ether, di-n-propyl ether, di-n-butyl ether, di-octyl ether, di-benzyl ether, di-phenyl ether, anisole, 1,2-dimethyloxyethane, o-dimethyloxy benzene, and cyclic ethers, such as tetrahydrofuran.

Even with controlled monomer addition and/or the use of a randomizer, the initial and terminal portions of the polymer chains may have greater than a “random” amount of polymer derived from the more reactive and less reactive monomer, respectively. Therefore, for the purpose of this disclosure, the term “random copolymer” means a polymer chain, or a polymer block, the preponderance of which (greater than 80%, preferably greater than 90%, such as greater than 95%) results from the random addition of comonomer materials.

The solvents in which the living polymers are formed are inert liquid solvents, such as hydrocarbons e.g., aliphatic hydrocarbons such as pentane, hexane, heptane, octane, 2-ethylhexane, nonane, decane, cyclohexane, methylcyclohexane, or aromatic hydrocarbons e.g., benzene, toluene, ethylbenzene, the xylenes, diethylbenzenes, propylbenzenes. Cyclohexane is preferred. Mixtures of hydrocarbons e.g., lubricating oils, may also be used.

The temperature at which the polymerization is conducted may be varied within a wide range, such as from about −50° C. to about 150° C., preferably from about 20° C. to about 80° C. The reaction is suitably carried out in an inert atmosphere, such as nitrogen, and may optionally be carried out under pressure e.g., a pressure of from about 0.5 to about 10 bars.

The concentration of the initiator used to prepare the living polymer may also vary within a wide range and is determined by the desired molecular weight of the living polymer.

To provide a star polymer, the living polymers formed via the foregoing process may be reacted in an additional reaction step, with a polyalkenyl coupling agent. Polyalkenyl coupling agents capable of forming star polymers have been known for a number of years and are described, for example, in U.S. Pat. No. 3,985,830. Polyalkenyl coupling agents are conventionally compounds having at least two non-conjugated alkenyl groups. Such groups are usually attached to the same or different electron-withdrawing moiety e.g. an aromatic nucleus. Such compounds have alkenyl groups that are capable of independent reaction with different living polymers and in this respect are different from conventional conjugated diene polymerizable monomers such as butadiene, isoprene, etc. Pure or technical grade polyalkenyl coupling agents may be used. Such compounds may be aliphatic, aromatic or heterocyclic. Examples of aliphatic compounds include the polyvinyl and polyallyl acetylene, diacetylenes, phosphates and phosphates as well as dimethacrylates, e.g. ethylene dimethylacrylate. Examples of suitable heterocyclic compounds include divinyl pyridine and divinyl thiophene.

The preferred coupling agents are the polyalkenyl aromatic compounds and most preferred are the polyvinyl aromatic compounds. Examples of such compounds include those aromatic compounds, e.g. benzene, toluene, xylene, anthracene, naphthalene and durene, which are substituted with at least two alkenyl groups, preferably attached directly thereto. Specific examples include the polyvinyl benzenes e.g. divinyl, trivinyl and tetravinyl benzenes; divinyl, trivinyl and tetravinyl ortho-, meta- and para-xylenes, divinyl naphthalene, divinyl ethyl benzene, divinyl biphenyl, diisobutenyl benzene, diisopropenyl benzene, and diisopropenyl biphenyl. The preferred aromatic compounds are those represented by the formula A—(CH═CH₂)ₓ wherein A is an optionally substituted aromatic nucleus and x is an integer of at least 2. Divinyl benzene, in particular meta-divinyl benzene, is the most preferred aromatic compound. Pure or technical grade divinyl benzene (containing other monomers e.g. styrene and ethyl styrene) may be used. The coupling agents may be used in admixture with small amounts of added monomers which increase the size of the nucleus, e.g. styrene or alkyl styrene. In such a case, the nucleus can be described as a poly(dialkenyl coupling agent/monoalkenyl aromatic compound) nucleus, e.g. a poly(divinylbenzene/monoalkenyl aromatic compound) nucleus.

The polyalkenyl coupling agent should be added to the living polymer after the polymerization of the monomers is substantially complete, i.e. the agent should be added only after substantially all the monomer has been converted to the living polymers.

The amount of polyalkenyl coupling agent added may vary within a wide range, but preferably, at least 0.5 mole of the coupling agent is used per mole of unsaturated living polymer. Amounts of from about 1 to about 15 moles, preferably from about 1.5 to about 5 moles per mole of living polymer are preferred. The amount, which can be added in two or more stages, is usually an amount sufficient to convert at least about 80 wt. % to 85 wt. % of the living polymer into star-shaped polymer.

The coupling reaction can be carried out in the same solvent as the living polymerization reaction. The coupling reaction can be carried out at temperatures within a broad range, such as from 0° C. to 150° C., preferably from about 20° C. to about 120° C. The reaction may be conducted in an inert atmosphere, e.g. nitrogen, and under pressure of from about 0.5 bar to about 10 bars.

The resulting linear or star-shaped copolymers can then be hydrogenated using any suitable means. A hydrogenation catalyst may be used e.g. a copper or molybdenum compound. Catalysts containing noble metals, or noble metal-containing compounds, can also be used. Preferred hydrogenation catalysts contain a non-noble metal or a non-noble metal-containing compound of Group VIII of the periodic Table i.e., iron, cobalt, and particularly, nickel. Specific examples of preferred hydrogenation catalysts include Raney nickel and nickel on kieselguhr. Particularly suitable hydrogenation catalysts are those obtained by causing metal hydrocarbyl compounds to react with organic compounds of any one of the group VIII metals iron, cobalt or nickel, the latter compounds containing at least one organic compound that is attached to the metal atom via an oxygen atom. Preference is given to hydrogenation catalysts obtained by causing an aluminum trialkyl (e.g. aluminum triethyl(Al(Et₃) or aluminum triisobutyl) to react with a nickel salt of an organic acid (e.g. nickel diisopropyl salicylate, nickel naphthenate, nickel 2-ethyl hexanoate, nickel di-tert-butyl benzoate, nickel salts of saturated monocarboxylic acids obtained by reaction of olefins having from 4 to 20 carbon atoms in the molecule with carbon monoxide and water in the presence of acid catalysts) or with nickel enolates or phenolates (e.g., nickel acetonylacetonate, the nickel salt of butylacetophenone). Suitable hydrogenation catalysts will be well known to those skilled in the art and the foregoing list is by no means intended to be exhaustive.

The hydrogenation of the polymers of the present disclosure is suitably conducted in solution, in a solvent which is inert during the hydrogenation reaction.

Saturated hydrocarbons and mixtures of saturated hydrocarbons are suitable. Advantageously, the hydrogenation solvent is the same as the solvent in which polymerization is conducted. Suitably, at least 50%, preferably at least 70%, more preferably at least 90%, most preferably at least 95% of the original olefinic unsaturation is hydrogenated.

Alternatively, the linear and star polymers of the present disclosure can be selectively hydrogenated such that the olefin saturations are hydrogenated as above, while the aromatic unsaturations are hydrogenated to a lesser extent. Preferably, less than 10%, more preferably less than 5% of the aromatic unsaturations are hydrogenated.

Selective hydrogenation techniques are also well known to those of ordinary skill in the art and are described, for example, in U.S. Pat. Nos. 3,595,942, 5,166,277.

The polymer may then be recovered in solid form from the solvent in which it is hydrogenated by any convenient means, such as by evaporating the solvent.

The linear and star polymers of the present disclosure are used principally in the formulation of polymer emulsions and slurries for secondary battery electrode coatings.

### Surfactants/Emulsifiers

Surfactants may also be referred to as emulsifiers or emulsifying agents herein and are used to disperse the styrene-diene polymer in the aqueous phase of the emulsion. The surfactants used herein are not particularly limited, and may include, for example, fatty acid soaps and rosin soaps. As specific examples of the fatty acid soaps, there can be sodium salts and potassium salts of a long chain fatty acid having 12 to 18 carbon atoms, such as lauric acid, myristic acid, palmitic acid, stearic acid, oleic acid or a mixed fatty acid thereof. As specific examples of the rosin soaps, there can be sodium salts and potassium salts of a disproportionated or hydrogenated product of natural rosin, such as gum rosin, wood rosin or tall oil rosin.

The surfactants used in the styrene-diene polymer emulsion compositions disclosed herein may be classified as ionic, or non-ionic, and are preferably water soluble. Ionic surfactants or emulsifiers used herein may be anionic, cationic, amphoteric, or combinations thereof. A wide variety of surfactants may be used as emulsifying agents herein, including anionic surfactants, cationic surfactants, nonionic surfactants, amphoteric surfactants, and combinations thereof.

Preferred water-soluble emulsifiers are ionic surfactants or ionic emulsifiers. Anionic surfactants that may be used in in the styrene-diene polymer emulsion compositions disclosed herein, may include alkali or ammonium soaps of resin acids and/or fatty acids, for instance of oleic acid, palmitic acid, stearic acid, lauric acid, myristic acid, arachic acid, ricinic acid. Other suitable anionic type surfactants are the alkali or ammonium soaps of branched carboxylic acids, of alkyl or arylsulphuric acids, of alky or arylsulphonic acids, as well as of sulphated or sulphonated glycidyl esters of carboxylic acids. Other examples of anionic surfactants or emulsifiers for use in the styrene-diene polymer emulsion compositions disclosed herein include, but are not limited to, anionic surface active agents such as higher alcohol sulfate esters, alkylbenzenesulfonate salts, aliphatic sulfonate salts, polyoxyethylene alkylarylsulfonate salts and polyphosphate salts. Other non-limiting exemplary anionic surfactants include soaps, turkey red oil, emulsifying oils, alkyl naphthalene sulfonates, dodecylbenzene sulfonate, oleate salts, alkylbenzene sulfonates, dialkyl sulfosuccinates, lignine sulfonate, alcohol ethoxysulfates, secondary alkanesulfonates, alpha-olefinsulfonic acids, and Tamol™. Still other exemplary anionic surfactants include fatty acids, e.g., myristic acid, palmitic acid, oleic acid, rinoleic acid, and salts thereof, alkylarylsulfonic acid salts, sulfuric acid esters of higher alcohols, alkyl sulfosuccinates, and combinations thereof. Still further other exemplary anionic surfactants are alkyl aryl sulfonates such as dodecyl benzene sodium sulfonate, dodecyl phenyl ether sodium sulfonate or the like; sulfosuccinate such as dioctyl sodium sulfosuccinate, dihexyl sodium sulfosuccinate or the like; salt of fatty acid such as sodium laurate or the like; ethoxy sulfate such as polyoxyethylene lauryl ether sodium sulfate or the like; alkane sulfonate; and alkyl ether sodium phosphate or the like.

Cationic surfactants that may be used in in the styrene-diene polymer emulsion compositions disclosed herein, may include aliphatic amine salts and quaternary ammonium salts thereof, aromatic quaternary ammonium salts, heterocyclic quaternary ammonium salts, and combinations thereof. Other, non-limiting exemplary cationic surfactants may include alkyl trimethyl ammonium salts, dialkyl dimethyl ammonium salts, alkyl pyrizinium salts, and alkyl benyl dimethyl ammonium salts. Still other exemplary cationic surfactants may include trimethyl ammonium chloride, dialkylammonium chloride, benzylammonium salt, quaternary ammonium salts, and combinations thereof.

Non-ionic surfactants that may be used in in the styrene-diene polymer emulsion compositions disclosed herein, include, but are not limited to, polyoxyethylene alkyl ethers, polyoxyethylene alkyl aryl ethers, polyoxyethylene fatty acid esters, polyoxyethylene sorbitan fatty acid esters, polyoxyethylene oxypropylene block polymers, akylsulfinyl alcohols, fatty acid monoglycerides, and combinations thereof. Other exemplary non-ionic surfactants include polyoxyethylene alkyl ether, polyoxyethylene alkylphenol ether, polyoxyethylene alkyl ester, and polyoxyethylene sorbitan alkyl ester. The non-ionic surfactant is advantageously a polyoxyethylene alkyl ether such as polyoxyethylene lauryl ether, polyoxyethylene cetyl ether, polyoxyetheylene stearyl ether or polyoxyethylene oleyl ether; polyoxyethylene alkyl aryl ether such as polyoxyethylene nonyl phenyl ether or polyoxyethylene octyl phenyl ether; polyethylene glycol fatty acid ester, polyethylene glycol phosphate; sorbitol fatty acid ester; fatty acid monoglyceride; polyglycerine fatty acid ester; propyleneglycol fatty acid ester; cane sugar fatty acid ester, polyoxyethylene-polyoxypropylene block copolymer; polyoxyethylene-polyoxypropylene alkyl ether; ethylene oxide derivative of alkyl phenol formalin condensate; polyoxyethylene glycerine fatty acid ester, polyoxyethylene hardened castor oil; polyoxyethylene sorbitol fatty acid ester; fatty acid alkanolamide; polyoxyethylene fatty acid amide; and combinations thereof. The nonionic surfactant disclosed herein may be alternatively used with a water soluble polymer, such as, for example, polyethylene oxide (PEO), polyvinyl alcohol (PVA), carboxymethyl cellulose, polyacrylic acid, and combinations thereof.

Amphoteric surfactants that may be used in the styrene-diene polymer emulsion compositions disclosed herein, may include, for example, carboxybetaine, sulfobetaine, aminocarboxylate salts, imidazoline derivatives, alkyl betaines, alkyl diethylenetriaminoacetates, and combinations thereof.

### Secondary Battery Electrode Slurry Compositions

Also provided herein are electrode slurry compositions for use in a secondary metal ion battery composition. The electrode slurry composition includes the aqueous based styrene-diene polymer emulsion composition disclosed above and additionally includes one or more co-binders, one or more conductive carbon-based particles, and one or more of silicon-based particles. The one or more conductive carbon-based particles may be selected from the group consisting of carbon nanotubes, graphite, and combinations thereof. The one or more of silicon-based particles may be selected from the group consisting of silicon particles, silicon alloy particles, silica particles or combinations thereof.

The electrode slurry compositions for use in a secondary metal ion battery composition disclosed herein may improve the life of the secondary metal ion battery, but at least 1%, or at least 2%, or at least 3%, or at least 4%, or at least 5%, or at least 7%, or at least 10%, or at least 15%, or at least 20%. The electrode slurry compositions for use in a secondary metal ion battery composition disclosed herein may also improve the charge capacity retention of the secondary metal ion battery, but at least 1%, or at least 2%, or at least 3%, or at least 4%, or at least 5%, or at least 7%, or at least 10%, or at least 15%, or at least 20%.

### Co-binders For Slurry Compositions

The electrode slurry compositions for use in a secondary metal ion battery composition disclosed herein include one or more co-binders. Non-limiting exemplary co-binders include polyacrylic acid (PAA), carboxymethyl cellulose (CMC), sodium alginate (SA), polyvinyl alcohol (PVA), chitosan (CS), polyacrylonitrile (PAN), polyimide (PI), gum arabic (GA), guar gum (GG), and combinations thereof. Other non-limiting exemplary co-binders include alginic acid and their various salts. Still other non-limiting exemplary co-binders include carboxy methyl cellulose (CMC)-based binders and its various salts (including but not limited to Na-CMC, Li-CMC, K-CMC, etc. and their mixtures may also be used as co-binders herein. In some designs, Li-salt of CMC may often be particularly favorable, and more particularly including those that additionally comprise elastic polymer nanoparticles, such as styrene butadiene rubber (SBR); polyacrylic acid (PAA) and their various salts (including but not limited to Na-PAA, Li-PAA, K-PAA, Ca-PAA and others and their mixtures. In some forms, Li-PAA salt may often be particularly favorable; (poly) alginic acid and various salts of (poly) alginic acid (Na-alginate, Li-alginate, Ca-alginate, K-alginate and many others and their various mixtures. In some forms, Li-alginate salt may often be particularly favorable) as well as maleic acid and their various salts (e.g., Li, Na, K, etc.). In other forms, Li-salt may often be particularly favorable), various (poly) acrylates (including, but not limited to dimethylaminoethyl acrylate and many others), various (poly) acrylamides, various polyesters, styrene butadiene rubber (SBR), (poly)ethylene oxide (PEO), (poly) vinyl alcohol (PVA), cyclodextrin, maleic anhydride, methacrylic acid and its various salts (Li, Na, K, etc.). In yet other forms, Li-salt may often be particularly favorable) as well as various (poly)ethylenimines (PEI), various (poly)amide imides (PAI), various (poly)amide amines, various other polyamine-based polymers, sulfonic acid and their various salts, various catechol group-comprising polymers, various lignin-comprising or lignin-derived polymers, various epoxies, various cellulose-derived polymers (including, but not limited to nanocellulose fibers and nanocrystals, carboxyethyl cellulose, etc.), chitosan, other polymers (e.g., preferably water-soluble polymers) and their various co-polymers and mixtures thereof.

### Anode Active Materials (Carbon-Based and Silicon-Based Materials)

The electrode slurry compositions for use in a secondary metal ion battery composition disclosed herein include one or more active materials, such as for example, anode active materials. Active materials include carbon-based active materials or particles, silicon-based active materials or particles, and combinations thereof.

In one form, the electrode slurry compositions for use in a secondary metal ion battery composition disclosed herein include various carbon-based active materials and/or silicon-based active materials including, but not limited to, graphite, silicon, silicon oxide, silicon-graphene, silicon-aluminum alloy, tin/graphene, and various polymer binders (described above). Exemplary carbon-based active materials include graphite, carbon nanotubes, and combinations thereof. In one form, the carbon-based active material may have particle sizes of greater than equal to 10 μm, or greater than equal to 15 μm, or greater than equal to 20 μm, or greater than equal to 25 μm, or greater than equal to 30 μm, or greater than equal to 35 μm, or greater than equal to 40 μm, or greater than equal to 45 μm, or greater than equal to 50 μm. In another form, the carbon-based active material may have particle sizes of less than equal to 10 μm, or less than equal to 8 μm, or less than equal to 6 μm, or less than equal to 4 μm, or less than equal to 2 μm, or less than equal to 1 μm, or less than equal to 0.5 μm. In yet another form, the carbon-based active material may include a first carbon-based active material, such as graphite, having particle sizes of more than about 10 μm, and a second carbon based active materials, such as graphite, having particles sizes of less than about 10 μm.

Exemplary silicon-based active materials include silicon particles, silicon alloy particles, silica particles or combinations thereof. Silicon-based materials may also include nanoparticles, nanowire and silicon/graphene composites. Silicon nanoparticle and nanowire anodes are expected to benefit from a fairly high binder loading (less than 15 wt %) and solvent in a wet electrode coating process because of the high surface area of these materials. One particularly advantageous anode active material for use in anodes is a combination of silicon and graphite to form a silicon/graphite composite. In another form, the silicon-based active material may have particle sizes of greater than equal to 10 nm, or greater than equal to 15 nm, or greater than equal to 20 nm, or greater than equal to 25 nm, or greater than equal to 30 nm, or greater than equal to 35 nm, or greater than equal to 40 nm, or greater than equal to 45 nm, or greater than equal to 50 nm, or greater than equal to 60 nm, or greater than equal to 70 nm, or greater than equal to 80 nm, or greater than equal to 90 nm, or greater than equal to 100 nm, or greater than equal to 120 nm, or greater than equal to 140 nm, or greater than equal to 160 nm, or greater than equal to 180 nm, or greater than equal to 200 nm. In another form, the silicon-based active material may have particle sizes of greater than equal to 100 μm, or greater than equal to 150 μm, or greater than equal to 200 μm, or greater than equal to 250 μm, or greater than equal to 300 μm, or greater than equal to 350 μm, or greater than equal to 400 μm, or greater than equal to 450 μm, or greater than equal to 500 μm.

The active materials and methods described herein may offer an advantage at higher silicon content in a composite anode electrode film, and may provide high energy density electrodes. A dry anode electrode film including a silicon/graphite composite anode active material as described herein may deliver electrochemical charge capacity comparable to its theoretical charge capacity. Thus, the silicon active materials in a dry silicon/graphite composite anode electrode film may be electrochemically active and accessible over a charge/discharge cycle.

### Method of Making Polymer Emulsion Compositions

Also disclosed herein are methods of making aqueous based styrene-diene polymer emulsion compositions. The methods include the following steps: i) providing one or more polymers comprising linear polymers characterized by the formula: D′-PA-D″; star polymers characterized by the formula: (D′-PA-D″) n-X; or combinations thereof; wherein D′ represents a block derived from diene; PA represents a block derived from monoalkenyl arene; D″ represents a block derived from diene; n represents the average number of arms per star polymer formed by the reaction of 2 or more moles of a polyalkenyl coupling agent per mole of arms; and X represents a nucleus of a polyalkenyl coupling agent; wherein at least one of diene blocks D′ and D″ is a copolymer block derived from mixed diene monomer, in which from 65 wt. % to 95 wt. % of the incorporated monomer units are from isoprene and from 5 wt. %, up to 35 wt. % of the incorporated monomer units are from butadiene; wherein at least 80 wt. % of the butadiene is incorporated in a 1, 4-configuration; and wherein D′ has a number average molecular weight of from 10,000 to 120,000 daltons; PA has a number average molecular weight of from 10,000 to 50,000 daltons; and D″ has a number average molecular weight of from 5,000 to 60,000 daltons.

The methods next involve the step of: ii) dissolving the one or more polymers into one or more organic solvents to form one or more dissolved polymers. The methods then include the step of: iii) providing an aqueous surfactant solution including one or more surfactants selected from the group consisting of anionic surfactants, cationic surfactants, nonionic surfactants, amphoteric surfactants, and combinations thereof; and followed by the step of: iv) combining and mixing the one or more dissolved polymers and the aqueous surfactant solution.

The methods disclosed herein then include the step of: v) further mixing the combined one or more dissolved polymers and aqueous surfactant; and finally the step of: vi) stirring the mixed one or more dissolved polymers and aqueous surfactant solution at a temperature of from 20 to 75° C., or 25 to 70° C., or 30 to 65° C., or 35 to 60° C., or 40 to 55° C. and for a sufficient time to completely evaporate the one or more organic solvents to form the aqueous based styrene-diene polymer emulsion composition. A sufficient time may be a time to evaporate at least 95 wt %, or at least 98 wt. %, or at least 99 wt. %, or at least 99.5 wt. %, or at least 99.9 wt. %, or at least 99.99 wt. % of the one or more organic solvents. A sufficient time may be at least 15 minutes, or at least 30 minutes, or at least 45 minutes, or at least 60 minutes, or at least 75 minutes, or at least 90 minutes, or at least 105 minutes, or at least 120 minutes. The mixing step v) may be done for example using mixing tools or devices to create high shear force. Non-limiting examples of such devices to create high shear force are high shear mixers, ultrasonicators, high-power dispersers, and/or homogenizers.

The methods disclosed herein provide aqueous based styrene-diene polymer emulsion compositions that include from 1 to 60 wt. % of one or more polymers; from 0.05 to 5.0 wt. % of one or more surfactants selected from the group consisting of anionic surfactants, cationic surfactants, nonionic surfactants, amphoteric surfactants, and combinations thereof; and with the remainder of the composition comprising water.

For the step of: ii) dissolving the one or more polymers into one or more organic solvents to form one or more dissolved polymers, the one or more organic solvents may include, but are not limited to, cyclohexane, tetrahydrofuran, dichloromethane, toluene, benzene, xylene, heptane, isooctane, and combinations thereof. Other non-limiting organic solvents that function as emulsion solvents in the dissolving step ii) may include benzene, toluene, xylene, and ethylbenzene; halogenated hydrocarbons solvents such as dichloroethane, chloroform, and chlorobenzene; carbon tetrachloride; ketones such as methyl ethyl ketone, acetone, cyclohexanone, and cyclopentanone; esters such as methyl acetate, ethyl acetate, propyl acetate, and butyl acetate; higher alcohols such as diacetone alcohol and benzyl alcohol; ethers such as dioxane and tetrahydrofuran; nitriles such as acetonitrile, acrylonitrile, and propionitrile; and so on. Each of these organic or emulsion solvents may be used singly or in combination with each other.

### Method of Making Electrode Slurry Compositions

Also disclosed herein are methods of making an electrode slurry composition for a secondary metal ion battery, which includes the steps of: i. dispersing into an aqueous solution one or more conductive carbon-based particles, and one or more of silicon-based particles; ii. mixing into the aqueous solution an aqueous based styrene-diene polymer emulsion composition as described above; and iii. further mixing into the aqueous solution one or more co-binders to form the electrode slurry composition. As described above, the one or more conductive carbon-based particles may include, but are not limited to, of carbon nanotubes, graphites; and combinations thereof. Other conductive carbon-based particles as described above may also be utilized. As described above, the one more co-binders may include, but are not limited to, polyacrylic acid, carboxymethyl cellulose, hydroxyethyl cellulose, polyvinyl alcohol, polyurethane. Other co-binders as described above may also be utilized.

### Secondary Metal Ion Battery Anodes

Also disclosed herein are secondary metal ion battery anodes that include a copper foil substrate having a thickness of from 5 to 50 microns, or 10 to 45 microns; or 15 to 40 microns, or 20 to 35 microns, or 25 to 30 microns. The secondary metal ion battery anodes also include a continuous coating layer having a thickness of from 50 to 500 microns, or 100 to 450 microns, or 150 to 400 microns, or 200 to 350 microns, or 250 to 300 microns on one surface of the copper foil substrate. The continuous coating layer includes from 10 to 80 wt. %, or 15 to 75 wt. %, or 20 to 70 wt. %, or 25 to 65 wt. %, or 30 to 60 wt. %, or 35 to 55 wt. %, or 40 to 50 wt. % of one or more conductive carbon-based particles; from 1 to 80 wt. %, or 5 to 75 wt. %, or 10 to 70 wt. %, 15 to 65 wt. %, or 20 to 60 wt. %, or 25 to 55 wt. %, or 30 to 50 wt. %, or 35 to 45 wt. % of one or more of silicon-based particles; from 1 to 10 wt. %, or 2 to 8 wt. %, or 4 to 6 wt. % of one or more polymer binders comprising linear polymers characterized by the formula: D′-PA-D″; star polymers characterized by the formula: (D′-PA-D″) n-X; or combinations thereof. The D′ represents an “outer” block derived from diene having a number average molecular weight of from about 10,000 to about 120,000 daltons; PA represents a block derived from monoalkenyl arene having a number average molecular weight of from about 10,000 to about 50,000 daltons; D″ represents an inner random derived from diene having a number average molecular weight of from about 5,000 to about 60,000 daltons; n represents the average number of arms per star polymer formed by the reaction of 2 or more moles of a polyalkenyl coupling agent per mole of arms; and X represents a nucleus of a polyalkenyl coupling agent.

The secondary metal ion battery anodes disclosed herein also include in the continuous coating layer described above from 0 to 10 wt. %, or 1 to 8 wt. %, or 2 to 6 wt. % for 3 to 5 wt. % of one or more co-binders. As described above, the one or more conductive carbon-based particles may include, but are not limited to, of carbon nanotubes, graphites; and combinations thereof. Other conductive carbon-based particles as described above may also be utilized in the continuous coating layer of the anodes. As described above, the one more co-binders may include, but are not limited to, polyacrylic acid, carboxymethyl cellulose, hydroxyethyl cellulose, polyvinyl alcohol, polyurethane. Other co-binders as described above may also be utilized in the continuous coating layer of the anodes.

### Test Methods

Properties indicated in the Examples and the methods by which they are measured are as follows:

The phrase “number average molecular weight”, as used herein, refers to the number average molecular weight as measured by Gel Permeation Chromatography (“GPC”) with a polystyrene standard.

“Crystallinity” in ethylene-alpha-olefin polymers can be measured using X-ray techniques known in the art as well as by the use of a differential scanning calorimetry (DSC) test. DSC can be used to measure crystallinity as follows: a polymer sample is annealed at room temperature (e.g., 20-25° C.) for at least 24 hours before the measurement. Thereafter, the sample is first cooled to −100° C. from room temperature, and then heated to 150° C. at 10° C./min. Crystallinity is calculated as follows:

$$\% Crystallinity = ( \sum Δ H ) \times {x}_{methylene} \times \frac{14}{4110} \times 100 \% ,$$

wherein ΣΔH (J/g) is the sum of the heat absorbed by the polymer above its glass transition temperature, X_{methylene} is the molar fraction of ethylene in the polymer calculated, e.g., from 1H NMR data, 14 (g/mol) is the molar mass of a methylene unit, and 4110 (J/mol) is the heat of fusion for a single crystal of polyethylene at equilibrium.

Electrical conductivity of the films of the aqueous based polymer emulsion composition is measured by ASTM F1529-02.

Battery life (cycling charge retention) is measured by cycling the battery cell at a certain charge/discharge rate (C/10-1C as described in the examples) until the end of life of the battery. In the examples in this invention disclosure, after 1 cycle at C/20, 9 cycles at C/10, the battery cells were then charged/discharged at C/5 until the end of the cycling test.

Battery rate capability or rate performance test is measured by cycling the battery cell at multiple charge/discharge rates for 5-7 cycles per C-rate with the last rate to be the same as the first rate, with the aim to understand how the battery behaves under different levels of stress. In the examples in this invention disclosure, rates used in this test were: C/20, C/10, C/5, C/2, and 1C with 5 cycles at each rate.

Adhesion to the battery electrode is measured by peel strength per ASTM D6862-11.

This disclosure will be further understood by reference to the following (non-limiting) examples. In the Examples, all parts are parts by weight, unless otherwise noted.

### EXAMPLES

### Example 1

### Materials Used

Si nanoparticle (30-50 nm) was purchased from US Research Nanomaterials; MWCNT (FT9111) was purchased from Canao Technology; both TIMREX KS6 and Super C65 were supplied by Imerys; SPGPT-803 with particle sizes<50 μm was purchased from NEI Corp. Glass separator 1820 was purchased from Whatman. Polyacrylic acid was purchased directly from Sigma-Aldrich.

Procedure for Forming Slurry and Coating Slurry onto a Current Collector
1. Silicon powder C65, and MWCNT powders were dry milled in a planetary mill for two hours to form a Si—C composite powder.
2. The Si—C composite powder was then added to a jar with milling media along with SPGPT-803, TIMREX KS6, binders(s), and any additional solvent necessary to make a flowable slurry and placed on a roll jack overnight to form the composition in Table 1 below.
3. After mixing, the slurry was then poured onto the current collector (copper foil) on a benchtop coater in a fume hood.
4. After coating the slurry onto the copper foil to a wet thickness of greater than 100 microns, the coating was dried at 100° C. for 1-2 hours to form a dry coating thickness of about 75 microns to form a tape.
5. Once dry, the loading of the electrode active material was measured using a 2″×2″ representative sample of the tape.
6. If the loading in the previous step is acceptable, the tape was then calendared on a calendaring machine to form a compressed and connected tape.
7. 16 mm-diameter punches were then taken and dried at 80° C. under vacuum for at least 24 hours to be made into cells in an argon glovebox to form an anode for the assembly of a 2032 coin battery cell.
8. To assemble a 2032 coin cell, all parts are transferred into an Ar-purged glovebox. 2 drops of the electrolyte solutions of EC: DEC: DMC (1:1:1 v/v) in 1 M LiPF₆ was added to the cell cup and the cathode (Li metal used in this example) was the placed on it. 2-3 more drops of the same electrolyte solution were added before placing a Whatman 1820 glass separator. Then 2 more drops of this same electrolyte solution were added, followed by placing the counter anode tape (From Step 7). With the placement of spacers and a spring, a 2032 battery cell is fully assembled and ready to be tested after crimping and sealing.
9. Cells were tested for capacity retention and rate capability using test procedures indicated above in TEST METHOD.

TABLE 1
Anode Slurry Formulations

| | Inventive | Comparative |
|---|---|---|
| | formulation | formulation |
| Materials | Wt. % | Wt. % |
| Si powder | 20.0 | 20.0 |
| MWCNT (multi-walled carbon nano-tubes) | 5.00 | 5.00 |
| SPGPT-803 (graphite) | 55.00 | 55.00 |
| TIMREX KS6 (graphite) | 10.00 | 10.00 |
| C65 (conductive carbon) | 1.00 | 1.00 |
| Emulsified triblock star styrene-diene | 3.00 | |
| copolymer (Inventive binder) | | |
| Comparative binder | | 3.00 |
| Polyacrylic acid (cobinder) | 6.00 | 6.00 |

### Test Results

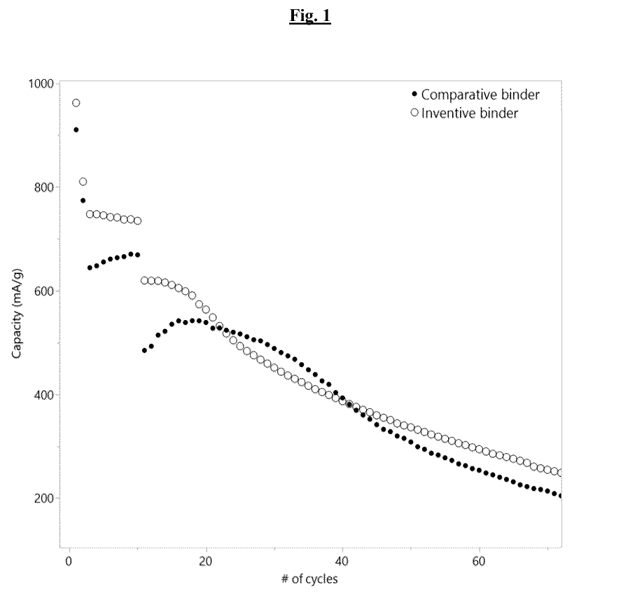

Battery cell testing data shows that the experimental emulsified triblock star styrene-diene copolymer inventive binder exhibits overall improvements in cell performance compared to the commercial benchmark comparative binder (styrene butadiene rubber). In particular, FIG. 1 depicts a graph of capacity retention as a function of the number of cycles of the battery showing better capacity retention when compared to the comparative binder. This improvement corresponds to a battery with longer battery life, providing a longer lasting and more stable battery.

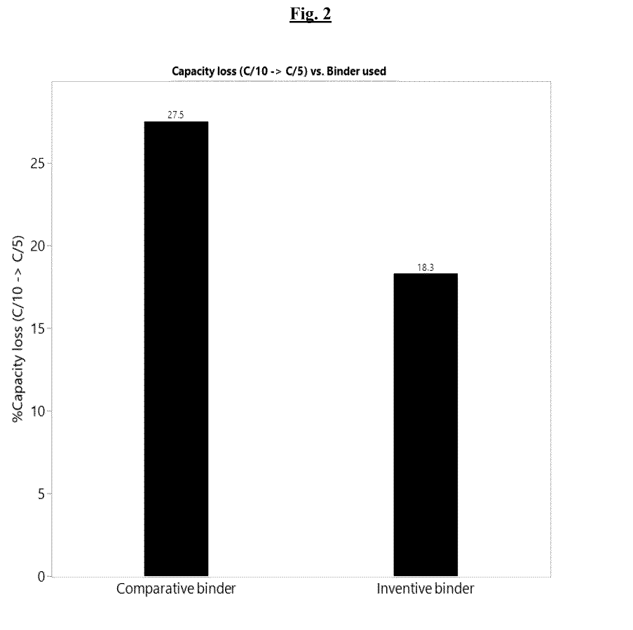

FIG. 2 depicts a graph of rate capability in 2 C-rates as function of the number of cycles of the battery also showing a significant improvement in the rate capability of the inventive binder compared to the battery made with the comparative binder. This enhanced feature shows that the battery with the emulsified triblock star styrene-diene copolymer binder behaves with more stability and provides higher capacity even at higher charging/discharging rates than the one made with the comparative binder.

Applicants have attempted to disclose all embodiments and applications of the disclosed subject matter that could be reasonably foreseen. However, there may be unforeseeable, insubstantial modifications that remain as equivalents. While the present invention has been described in conjunction with specific, exemplary embodiments thereof, it is evident that many alterations, modifications, and variations will be apparent to those skilled in the art in light of the foregoing description without departing from the spirit or scope of the present disclosure. Accordingly, the present disclosure is intended to embrace all such alterations, modifications, and variations of the above detailed description.

All patents, test procedures, and other documents cited herein, including priority documents, are fully incorporated by reference to the extent such disclosure is not inconsistent with this invention and for all jurisdictions in which such incorporation is permitted.

When numerical lower limits and numerical upper limits are listed herein, ranges from any lower limit to any upper limit are contemplated.

What is claimed is:

1. An aqueous based styrene-diene polymer emulsion composition comprising:
i) from 2 to 50 wt. % of one or more polymers comprising linear polymers characterized by the formula: 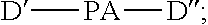
star polymers characterized by the formula: 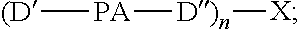
or combinations thereof;
wherein D′ represents a block derived from diene; PA represents a block derived from monoalkenyl arene; D″ represents a block derived from diene; n represents the average number of arms per star polymer formed by the reaction of 2 or more moles of a polyalkenyl coupling agent per mole of arms; and X represents a nucleus of a polyalkenyl coupling agent;
wherein at least one of diene blocks D′ and D″ is a copolymer block derived from mixed diene monomer, in which from 65 wt. % to 95 wt. % of the incorporated monomer units are from isoprene and from 5 wt. %, up to 35 wt. % of the incorporated monomer units are from butadiene;
wherein at least 80 wt. % of the butadiene is incorporated in a 1, 4-configuration; and
wherein D′ has a number average molecular weight of from 10,000 to 120,000 daltons; PA has a number average molecular weight of from 10,000 to 50,000 daltons; and D″ has a number average molecular weight of from 5,000 to 60,000 daltons;
ii) from 0.05 to 5.0 wt. % of one or more surfactants selected from the group consisting of anionic surfactants, cationic surfactants, nonionic surfactants, amphoteric surfactants, and combinations thereof; and
iii) the remainder of the composition comprising water.

2. The composition of claim 1, wherein the one or more anionic and cationic ionic surfactants are selected from the group consisting of sodium dodecyl sulfonate, alkyl surfactants, fluorine surfactants, metal surfactants, and combinations thereof.

3. The composition of claim 1, wherein the one or more non-ionic surfactants are selected from the group consisting of silicone surfactants, fluorine surfactants, alkyl surfactants, polyether-based surfactants, and combinations thereof.

4. The composition of claim 1, wherein the particle size of the emulsified styrene-diene polymer is from 50 to 1000 nm.

5. The composition of claim 1, wherein the pH the composition is from 4 to 10.

6. The composition of claim 1, wherein the viscosity of the composition is from 20 to 1000 cP at 25° C. as measured by ASTM D5133.

7. The composition of claim 1 including from 4 to 20 wt. % of the one or more polymers.

8. The composition of claim 1, wherein the one or more polymers comprise linear polymers.

9. The composition of claim 8, wherein the linear polymers are diblock, triblock or combinations thereof.

10. The composition of claim 1, wherein the one or more polymers comprise star polymers.

11. The composition of claim 10, wherein the star polymers arms are homopolymer, diblock, triblock, or combinations thereof.

12. The composition of claim 1, wherein D′ has a number average molecular weight of from 20,000 to 60,000 daltons.

13. The composition of claim 1, wherein D″ has a number average molecular weight of from 10,000 to 30,000 daltons.

14. The composition of claim 1, wherein PA has a number average molecular weight of from 12,000 to 35,000 daltons.

15. The composition of claim 1, wherein D′ has a number average molecular weight of from 20,000 to 60,000 daltons; D″ has a number average molecular weight of from 10,000 to 30,000 daltons; and PA has a number average molecular weight of from 12,000 to 35,000 daltons

16. The composition of claim 1, wherein the ratio between the number average molecular weight of D′ and the number average molecular weight of D″ is at least 1.4:1.

17. The composition of claim 1, wherein the ratio between the number average molecular weight of PA and the number average molecular weight of D″ is at least 0.75:1.

18. The composition of claim 11, wherein n is, on average, from 4 to 25.

19. The composition of claim 18, wherein n is, on average, from 10 to 20.

20. The composition of claim 18 having a total number average molecular weight of from 100,000 daltons to 1,000,000 daltons.

21. The composition of claim 18, wherein D′ has a number average molecular weight of from 20,000 to 60,000 daltons; D″ has a number average molecular weight of from 10,000 to 30,000 daltons; and PA has a number average molecular weight of from 12,000 to 35,000 daltons

22. The composition of claim 18, wherein the ratio between the number average molecular weight of D′ and the number average molecular weight of D″ is at least 1.4:1.

23. The composition of claim 18, wherein the ratio between the number average molecular weight of PA and the number average molecular weight of D″ is at least 0.75:1.

24. The composition of claim 9 having a total number average molecular weight of from 40,000 daltons to 1,000,000 daltons.

25. The composition of claim 1, wherein the electrical conductivity of a polymer film of the composition is from 0.00001 to 1 mS/cm.

26. An electrode slurry composition for a secondary metal ion battery composition including the aqueous based styrene-diene polymer emulsion composition of claim 1, one or more co-binders, one or more conductive carbon-based particles selected from the group consisting of carbon nanotubes, graphite, and combinations thereof, and one or more of silicon-based particles.

27. The electrode slurry composition of claim 26, wherein the silicon-based particles are selected from the group consisting of silicon particles, silicon alloy particles, silica particles or combinations thereof.

28. A method of improving the life of the secondary metal ion battery comprising using the electrode slurry composition of claim 26 as a binder for a coating of an anode of the secondary metal ion battery.

29. A method of making an aqueous based styrene-diene polymer emulsion composition comprising the steps of:
i) providing one or more polymers comprising linear polymers characterized by the formula: 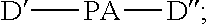
star polymers characterized by the formula: 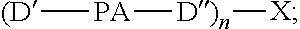
or combinations thereof;
wherein D′ represents a block derived from diene; PA represents a block derived from monoalkenyl arene; D″ represents a block derived from diene; n represents the average number of arms per star polymer formed by the reaction of 2 or more moles of a polyalkenyl coupling agent per mole of arms; and X represents a nucleus of a polyalkenyl coupling agent;
wherein at least one of diene blocks D′ and D″ is a copolymer block derived from mixed diene monomer, in which from 65 wt. % to 95 wt. % of the incorporated monomer units are from isoprene and from 5 wt. %, up to 35 wt. % of the incorporated monomer units are from butadiene;
wherein at least 80 wt. % of the butadiene is incorporated in a 1, 4-configuration; and
wherein D′ has a number average molecular weight of from 10,000 to 120,000 daltons; PA has a number average molecular weight of from 10,000 to 50,000 daltons; and D″ has a number average molecular weight of from 5,000 to 60,000 daltons;
ii) dissolving the one or more polymers into one or more organic solvents to form one or more dissolved polymers;
iii) providing an aqueous surfactant solution including one or more surfactants selected from the group consisting of anionic surfactants, cationic surfactants, nonionic surfactants, amphoteric surfactants, and combinations thereof;
iv) combining and mixing the one or more dissolved polymers and the aqueous surfactant solution;
v) further mixing the combined one or more dissolved polymers and aqueous surfactant solution; and
vi) stirring the mixed one or more dissolved polymers and aqueous surfactant solution at a temperature of from 20 to 75° C. and for a sufficient time to completely evaporate the one or more organic solvents to form the aqueous based styrene-diene polymer emulsion composition.

30. The method of claim 29, wherein the one or more organic solvents are selected from the group consisting of cyclohexane, tetrahydrofuran, dichloromethane, toluene, benzene, xylene, heptane, isooctane, and combinations thereof.

31. The method of claim 29, wherein the one or more anionic and cationic ionic surfactants ionic surfactants are selected from the group consisting of sodium dodecyl sulfonate, alkyl surfactants, silicone surfactants, fluorine surfactants, metal surfactants, and combinations thereof.

32. The method of claim 29, wherein the one or more non-ionic surfactants are selected from the group consisting of silicone surfactants, fluorine surfactants, alkyl surfactants, polyether-based surfactants, and combinations thereof.

33. The method of claim 29, wherein the mixing step of v) is done using high shear mixers, ultrasonicators, high-power dispersers, homogenizers or combinations thereof.

34. The method of claim 29, wherein the aqueous based styrene-diene polymer emulsion composition includes from 1 to 60 wt. % of one or more polymers; from 0.05 to 5.0 wt. % of the one or more ionic surfactants, one or more non-ionic surfactants, or a combination thereof; and the remainder of the composition comprising water.

35. A method of making an electrode slurry composition for a secondary metal ion battery comprising the steps of:
i. dispersing into an aqueous solution one or more conductive carbon-based particles selected from the group consisting of carbon nanotubes, graphites; and
combinations thereof, and one or more of silicon based particles;
ii. mixing into the aqueous solution an aqueous based styrene-diene polymer emulsion composition according to claim 1; and
iii. further mixing into the aqueous solution one or more co-binders selected from the group consisting of polyacrylic acid, carboxymethyl cellulose, hydroxyethyl cellulose, polyvinyl alcohol, polyurethane, polyacrylonitrile, polyimide and their derivatives, and combinations thereof to form the electrode slurry composition.

36. A secondary metal ion battery anode comprising:
a copper foil substrate having a thickness of from 5 to 50 microns; and
a continuous coating layer having a thickness of from 50 to 500 microns on one surface of the copper foil substrate;
wherein the continuous coating layer comprises:
from 10 to 80 wt. % of one or more conductive carbon-based particles selected from carbon nanotubes, graphites, and combinations thereof;
from 1 to 80 wt. % of one or more of silicon based particles;
from 1 to 10 wt. % of one or more polymer binders comprising linear polymers characterized by the formula: 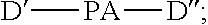
star polymers characterized by the formula: 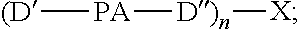
or combinations thereof, wherein D′ represents an “outer” block derived from diene having a number average molecular weight of from about 10,000 to about 120,000 daltons; PA represents a block derived from monoalkenyl arene having a number average molecular weight of from about 10,000 to about 50,000 daltons; D″ represents an inner random derived from diene having a number average molecular weight of from about 5,000 to about 60,000 daltons; n represents the average number of arms per star polymer formed by the reaction of 2 or more moles of a polyalkenyl coupling agent per mole of arms; and X represents a nucleus of a polyalkenyl coupling agent; and
from 0 to 10 wt. % of one or more co-binders selected from the group consisting of polyacrylic acid, carboxymethyl cellulose, hydroxyethyl cellulose, polyvinyl alcohol, polyurethane, and combinations thereof.
